(19) United States
(12) Patent Application Publication
(10) Pub. No.: US 2007/0041163 A1
(43) Pub. Date: Feb. 22, 2007

(54) Method for producing an electronic component or module and a corresponding component or module

(75) Inventors: Jacky Jouan, Dixmont (FR); Bachir Fordjani, Creil (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedex (FR)

(21) Appl. No.: 10/547,809

(22) PCT Filed: Mar. 3, 2004
(86) PCT No.: PCT/FR04/00505

§ 371 Date: Oct. 23, 2006

(30) Foreign Application Priority Data
Mar. 3, 2003 (FR) 03/02588

(51) Int. Cl. H01G 7/00; H01S 4/00

(52) U.S. Cl. 361/715; 29/25.42; 29/592.1; 29/832; 361/800

(57) ABSTRACT

A method is provided for producing a component or a module comprising a component assembly arranged on a substrate in a housing which is mountable on a printed circuit. The inventive method includes at least one stage when at least one part of the module is coated with an insulating material, and at least one stage when at least one conductive area is produced on one part of said insulating material in such a way that the areas forming and/or receiving at least one part of the component and/or at least one interconnection element are defined.

### FIELD OF THE INVENTION

The field of the invention is that of production of complex electronic components, and especially, though not exclusively, modules, arranging a component assembly on a substrate in the form of a sole and compact housing, such that it can be mounted on a printed circuit in the form of a sole element.

For example, in the case of a telecommunications terminal, such a module can regroup the essential components and software necessary for the functioning of this terminal. In certain cases, two (or more) modules can be provided, especially so as to optimise the management of space. In this case, they are advantageously interconnected numerically.

In the field of fabrication of electronic components and modules, a major objective is the reduction in overall bulkiness, and in particular the reduction of the occupied surface on a printed circuit.

The invention makes a new and very efficient solution to this objective.

### PRIOR ART

Distinction of Modules and Components

Hereinbelow the disadvantages of a module especially are specified. As will be seen hereinafter the invention can also be applied in the case of a more conventional component. Certain disadvantages discussed hereinbelow apply also to these components.

What is presented hereinbelow is only the most complex case of a module, which highlights even more outstandingly the disadvantages of the prior art.

Extraction of Bulky Components

A first solution for reducing the bulkiness of a module is naturally to remove from it one or more of the bulkiest components, and to then attach these directly on the client printed circuit.

This solution is not however desirable, since the module is no longer a complete solution, and since there is the added complexity of assembly (several components to be mounted on the printed circuit), and since it is also necessary to provide connections between the different elements.

The Mono Face CMS Modules

Generally, modules comprise a substrate whereof one face receives the components, and the other face receives the interconnection structure. It is therefore possible to obtain a low thickness. On the other hand, the occupied surface is relatively significant, and determined by the components and their optional shielding.

On the face dedicated to the interconnection, the entire surface however is not occupied, causing a loss of place.

Modules with Components and Interconnection on the Same Face

Based on this observation, it has been proposed to arrange the interconnection structure and at least certain of the components on the same face.

So it is this face which determines the necessary surface for the module.

This naturally causes a loss of the available surface for the interconnection.

The other face can be preserved without components, but there is again a loss of place, for receiving components and the shielding.

In general, it is observed that there is no solution optimising the utilisation of the available surface and thus allowing the surface occupied by the module on a printed circuit to be reduced.

The presence of screening, generally necessary on this module, especially when it uses RF components, again increases this bulkiness.

Furthermore, these components or modules generally have an increased cost associated inter alia with additional elements such as connectors, passive components or metallic screening components, which also increase the bulkiness.

Therefore, it is generally necessary to provide metallic screening and an interconnection structure. Similarly, making use of passive components, such as capacitors or resistors adds to the complexity of assembly and to the overall bulkiness.

Purposes of the Invention

The purpose of the invention especially is to eliminate these disadvantages inherent in the prior art.

More precisely a purpose of the invention is to provide a technique, which helps to reduce the size, and especially the surface occupied on a substrate, a module or an electronic component, naturally by retaining all functionalities of this module or of this component.

Another purpose of the invention is to provide such a technique, which enables the connector engineering and the assembly on a printed circuit to be simplified. In particular, a purpose of the invention is to go without connector components on a module.

Yet another purpose of the invention is to provide such a technique, which enables screening of the components to be optimised, and for example to allow selective screening of an element.

The purpose of the invention is also to provide such a technique, which allows complex and compact modules to be produced at an acceptable manufacturing cost, and by using accessible technologies.

Still another purpose of the invention is to provide such a technique, which enables components or modules to be made, themselves allowing new devices to be produced, at least in their form or design, due to the fact of their reduced bulkiness and their efficiency.

Principal Characteristics of the Invention

These purposes, as well as others, which will emerge hereinbelow are attained by means of a manufacturing process for a component or a module arranging in a housing ready to be mounted on a printed circuit a component assembly mounted on a substrate. According to the invention, this process comprises at least one coating stage by means of an insulating material of at least one part of said module and at least one production stage, on a part of said insulating material, of at least one conductive zone, so as to define zones forming and/or capable of receiving at least a part of a component and/or at least an interconnection element.

Accordingly, as will be seen hereinafter, it is possible to obtain more compact device, capable of arranging more components and integrating certain passive components, interconnection elements and screenings without purchase of specific component, but only by adapting the manufacturing process. The device obtained from this can also be mounted simply and directly on a printed circuit.

According to a first preferred aspect of the invention, at least one of said conductive zones thus defines an interconnection structure, allowing said module to be attached on a printed circuit.

In this case, said interconnection structure advantageously has at least one connection point, and at least one corresponding link, extending on at least one lateral edge of said housing as far as said substrate.

According to a preferred embodiment, said interconnection structure allows direct assembly on a printed circuit by brazing (without external interconnection element).

In particular, said interconnection structure can permit assembly on a printed circuit according to the CMS technique.

According to a second advantageous aspect of the invention, at least one of said conductive zones defines a passive component (or a portion of such a passive component).

The or said passive components can especially belong to the group comprising capacitors, the inductive resistors and the resistors, as well as their combinations.

Advantageously, at least one of said conductive zones is an electrode having a capacitor whereof the dielectric is formed by said insulating material. This can especially help optimise decoupling of the inlets/outlets.

According to a third aspect of the invention, the process preferably comprises producing at least two conductive zones designed to receive at least one component.

It is thus possible to attach one or more components on the surface of the module (or component). They can be mounted for example by brazing or by adhesion on the surface of the module.

According to a fourth aspect of the invention, the process advantageously comprises a previous coating stage of at least a part of said components, and a metallisation stage of the coated part, so as to ensure electro-magnetic screening, then a final coating stage.

The final coating can then be completed by duplicate moulding.

In an advantageous manner, independent screening of at least two sub-assemblies of components is carried out.

If heat-generating components are preferably present, at least one of said—assemblies is connected to an external radiator.

According to an advantageous characteristic of the invention, said coating and production stages of at least one conductive zone are reiterated at least once.

It is thus possible to optimise the compactness of the module even more.

According to a particular aspect of the invention, the process comprises utilising a metallisation layer forming a block plan.

Advantageously, at least one opening filled with a conductive material passing through at least one layer of coating is made. This allows the interconnection of several layers with one another or with the substrate.

The openings or said openings can especially be conical or tapered. They are for example made by mechanical boring, laser boring, chemical attack or moulding of the coating.

The openings or said openings are advantageously filled with a conductive material by serigraphy or pressurised filling, chemical and/or electrochemical baths.

According to another characteristic of the invention, said insulating material is a plastic material.

Said insulating material preferably has a thermal expansion coefficient selected such that it is compatible with that of the material of the printed circuit on which said component or module will be connected.

This allows greater reliability of the assembly on the printed circuit.

Said coating stage is advantageously selective, so as to spare at least a portion of the surface of said substrate, such as to present an electric continuity between at least one of said conductive zones and at least one of said surface portions.

Said coating stage can be especially made by casting material, injecting material or transfer of material, then polymerisation or sintering.

Said production stage of at least one conductive zone advantageously comprises a metallisation stage of the surface of said insulating material and a production stage of geometric forms allowing part of said metallisation to be eliminated.

Said metallisation stage can especially comprise surface treatment by at least chemical and/or electrochemical bath, conductive painting, pulverisation of conductive elements and/or vaporisation under vacuum.

Said production stage of geometric forms advantageously comprises three-dimensional etching by laser or selective development (MID: Molded Interconnection Device) or chemical attack.

Advantageously, the process can also comprise a stage for depositing a film of photosensitive organic material on said coating and the or said conductive zones.

According to another aspect of the invention, the process advantageously comprises a production stage of at least a thermal drain to aid the evacuation of the heat produced by at least one of said components.

The invention also concerns the components and the modules obtained according to the process described hereinabove. In the present description, the term module is used more often. It is clear however that the majority of the aspects (with the exception of those specific to the modules, and associated especially to the fact that such a module combines several components) can be applied in the same manner to a component and to a module.

More generally, a component or a module according to the invention comprises an insulating material coating at least a part of said module and at least one conductive zone on a part of said insulating material, such as to define zones forming and/or capable of receiving at least part of a component and/or at least an interconnection element.

Advantageously, at least one of said conductive zones defines an interconnection structure, allowing said module to be attached to a printed circuit.

Said module or component preferably carries at least one passive component defined by at least one of said conductive zones. Therefore, it can especially comprise at least one capacitor whereof the dielectric is formed by said insulating material and at least one electrode by one of said conductive zones.

Advantageously, said module or component carries at least one component connected to at least two of said conductive zones.

### LIST OF FIGURES

Other characteristics and advantages of the invention will emerge more clearly from reading the following description of preferred embodiments of the invention, given by way of simple illustrative and non-limiting examples, and the attached diagrams, in which:

FIGS. 1A and 1B illustrate, respectively, in a view from below, and in side elevation, a first example of a module according to the invention;

FIG. 2 illustrates the module in FIGS. 1A and 1B attached to a printed circuit;

FIGS. 3A to 3F illustrate different stages of manufacturing of an example of a module according to the invention;

FIGS. 4A and 4B illustrate the case of a capacitive effect made according to the technique of the invention;

FIG. 5 illustrates an example for attaching components on a module according to the invention;

FIG. 6 illustrates another example of implantation of components in a module according to the invention.

### DESCRIPTION OF PREFERRED EMBODIMENTS OF THE INVENTION

Reminder of Principle of the Invention

The invention is based on a quite novel approach of module production, or components, based especially on the utilisation of a coating as a support of conductive zones, on one or more faces and on one or more levels, these conductive zones having an active role in connection, components and/or screening.

The deposits of coating and conductive zones can be repeated a number of times, and can be made selectively on portions of the module or component.

This approach thus allows freeing of the surface on the substrate of the module, and thus limiting the surface which the latter occupies on a printed circuit.

This can especially enable the screening to be incorporated on and in the coating, the interconnection on the coating surface, components embedded in the coating, and/or components mounted on the surface of the coating.

It is evident that the owner of the present patent application has already presented, in the patent document FR-2808 164, a technique consisting of attaching a metallic surface to the entire coating of a component, so as to ensure screening of the latter. The present invention is based on a very different approach, according to which the metallic surface does not cover the entire surface of the coating, but is on the contrary distributed selectively, so a to impart specific functions to the conductive zones thus formed, especially connectic (to allow the module to be attached, and/or for receiving components) or again for directly forming certain passive components.

In this way, the invention proposes novel three-dimensional architecture of housing for electronic modules, or for components, with an insulating coating and selective metallisations for integrating:

an interconnection structure, for example of CMS type;

electromagnetic screening, which can be selective

the production of passive components;

the attaching of components on the module, elsewhere than on the surface of the substrate of the latter.

Example of a Module According to the Invention

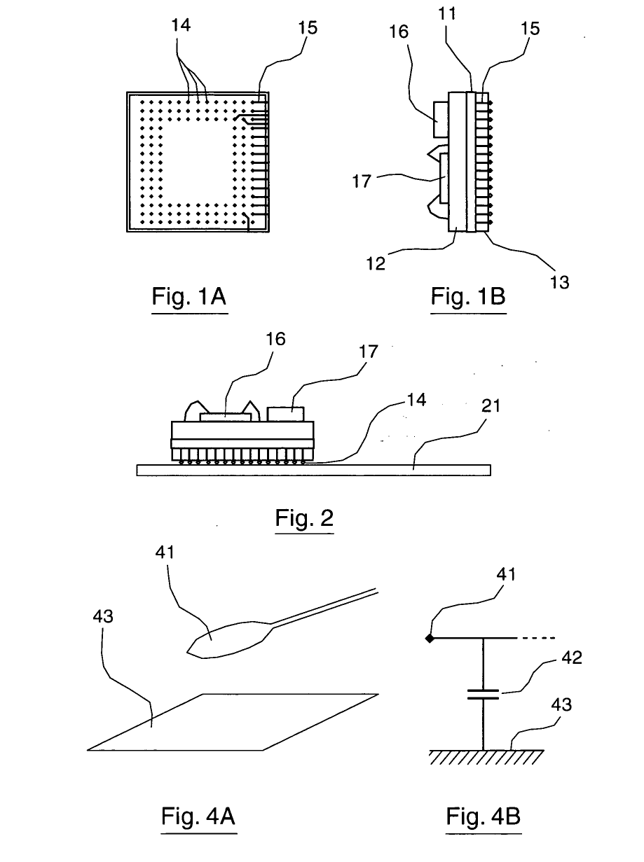

FIGS. 1A and 1B illustrate a first embodiment of a module according to the invention, respectively viewed from below and from the side.

The usual substrate 11, on which components have been conventionally mounted, is distinguished. It has been possible to attach these components on the two faces. The insulating coating 13 was then deposited on each of these faces 1.

This coating can also cover a screening.

On the lower face (FIG. 1A), and more precisely on the surface of the coating, conductive zones 14, which define an interconnection structure, have been made.

Each interconnection element can be attached to the substrate 11 (and more precisely a component carried by the latter) by a conductive track 15, which extends on the lateral edge of the housing (FIG. 1B). On the upper surface of the module, on a also attached components 16 and 17 at the surface, and these can be attached in the same manner to the substrate, or by means of traverse elements provided for this purpose.

This module can be directly attached on a printed circuit 21, such as an application card of a client, as is illustrated in FIG. 2. The link to this circuit 21 is ensured directly by the interconnections 14 made on the surface of the coating, without any interposition being necessary.

The result is thus a very simple assembly of CMS type, having reduced thickness. The surface occupied is also limited, due to the fact that certain components 16 and 17 are not present on the substrate 11, but are attached to the surface of the housing. As already indicated, these components could also be on an intermediate layer, itself again covered by a coating, then if necessary, by new components.

Example of Cancelling a Module According to the Invention.

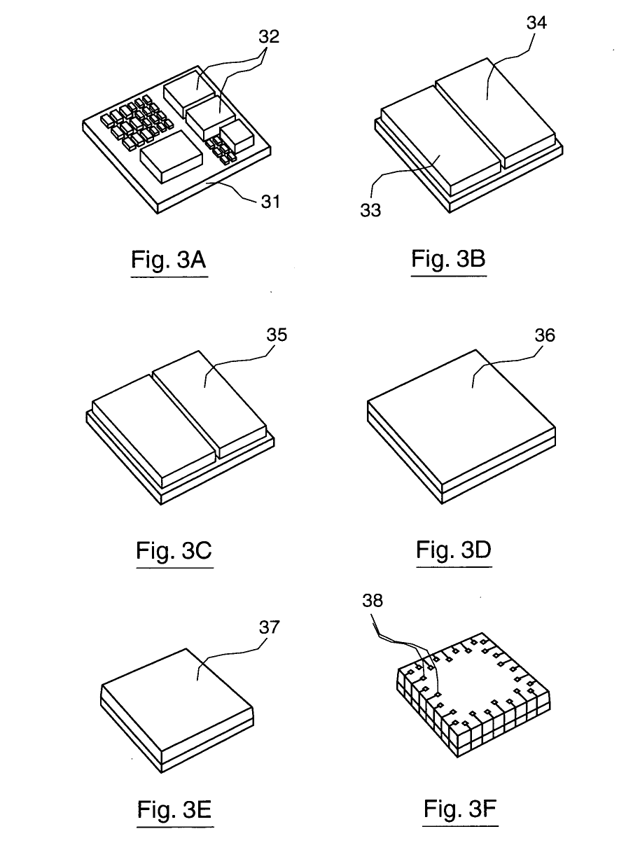

FIGS. 3A to 3F illustrate an example for production of a module according to the technique of the invention.

The successive stages are the following:

FIG. 3A: attached to a substrate 31 in conventional manner are components 32, preferably distributed, so as on the one hand to optimise utilisation of the surface, and on the other hand to combine the components according to their function, or again to remove the components capable of being perturbed, for example due to the fact of interference. In the case of the example illustrated, the components are combined in two corresponding zones respectively to the baseband and the radiofrequency of a radiotelephony module;

FIG. 3B: the two baseband and RF groups receive selective insulating coating 33, 34, for example according to a technology provided for producing plastic housings;

FIG. 3C: the surface of these two coated zones 33 and 34 is metallised (35), for example by chemical bath or painting, so as to ensure a efficacious and selective screening, for each of the functions. It is evident that this screening, known per se, has the advantage of reduced cost not requiring the purchase and assembly of components such as a metallic box;

FIG. 3D: plastic duplicate moulding 36 is then attached to the ensemble of the upper part of the module, to form a housing;

FIG. 3E: according to the invention metallisation 37 is applied to the complete surface of the duplicate-moulded housing 36, by adapted surface treatment;

FIG. 3F: then, part of the metallisation 37 is eliminated, so a to define the corresponding conductive zones 38, in the example illustrated, to the tracks and pellets of an interconnection structure, for example according to a three-dimensional etching technique.

It is seen that the stages of FIGS. 3E and 3F can be replaced by a sole stage of direct production of the desired conductive zones, for example by serigraphy.

The cost of interconnection is thus reduced, which corresponds only to a processing cost, without the necessity for purchasing a connector. In addition, it is noted that there is little or none of the surface of the substrate occupied by the interconnection.

Of course, the thermal expansion coefficients of the insulating material on the one hand, and of the material of the printed circuit on the other hand, are preferably selected so as to present good compatibility during attaching of the module to obtain greater reliability of the interconnection.

Integration of Depassive Components in the Coating

The technique of the invention also allows efficacious and simple integration of the passive components in the coating, as is illustrated by FIGS. 4A and 4B, in the case of a capacitive effect. FIG. 4A schematically shows the electrodes of a capacitor made according to the invention, and FIG. 4B illustrates the corresponding electrical plan.

The pellet 38 (FIG. 3F) is thus not only a connection element, but also an electrode 41 of a capacitor 42, whereof the other electrode 43 is formed by an internal conductive zone, made before the last layer of coating, and which can for example be a block plan (corresponding for example to internal screening).

The result therefore is a capacitive effect for example lending aid to the decoupling of the inlets/outlets. The cost of these passive components is only a processing cost, without purchase of any components. In addition, these components do not occupy any surface on the substrate of the module. The dielectric of the capacitor 43 is made by the insulating coating.

The choice of forms, thickness and surfaces of the insulating and conductive materials especially helps define capacitors or inductive resistors or resistors, or combinations of these elements.

Certain components (or portions of components), can also be made by an adapted choice of the surface of a conductive zone.

Double-Faced Module

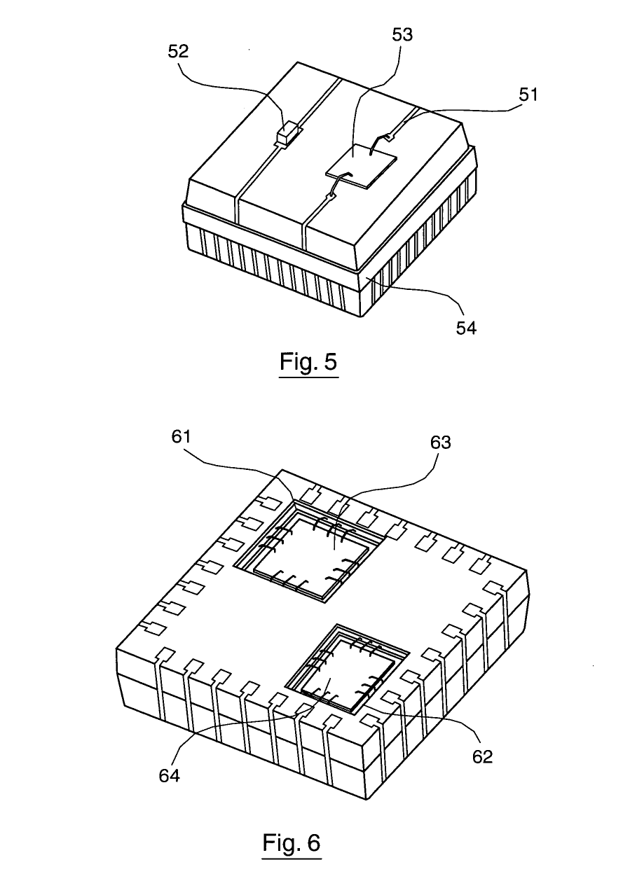

As is illustrated in FIG. 5, the technique of the invention again allows the distribution of the components to be optimised by mounting certain of them on at least one of the faces of the module. In this case, the conductive zones 51 are electrical tracks, permitting interconnection of the components 52 and 53 mounted on the surface with the other components of the substrate 54. This can especially be about CMS 52 components, or cable components (“wire bonding” or “flip chip”);

It is understood that the technique of the invention can be iterative, and that the treatment illustrated by FIGS. 3A to 3F can be repeated on the components 52 and 53 of FIG. 5.

The same approach could also be used on the lower surface of the component, especially by providing housings 61, 62, as illustrated in FIG. 6, such that the components 63, 64 do not exceed the surface.

In the example of FIG. 6, it can also be provided that the housings 61, 62 will be covered by a coating, and by shielding, if required.

Precision on the Fabrication of Modules or Components According to the Present Invention

The invention thus produces electronic modules, or components, in the form of a coated housing provided with a series of one or more coatings of electrically insulating materials interposed between one or more deposits of electrically conductive layers, whereof the definition of the surface geometric forms can ensure at least some of the following functions at the same time:

shielding of different independent regions, with a reduced occupied surface on the substrate of the module;

connection by brazing on a printed circuit without occupying any surface on the substrate of the module;

integration of electrical functions equivalent to passive elements, without occupying the corresponding volume on or in the substrate;

possibility of transferring components on the coating of the housing (and not on the substrate of the module, or on another placement of the printed circuit).

The electromagnetic shielding of the invention associates internal shielding and external shielding of one or more regions of the module, by creating a conductive envelope around the components of each of these regions, according to the principle of a cage Faraday brought back to mass.

This depositing of conductive layers can especially be done by:

pulverisation of conductive elements;

conductive painting;

attachment of conductive elements by a succession of one or more chemical and/or electrochemical baths.

The insulating coating receiving this layer is advantageously selective in the selection of materials, and to spare the defined surfaces of the substrate so as to present electrical continuity between the conductive deposit on the coating and the mass of the substrate.

This insulating coating can for example be carried out by:

casting of material and polymerisation or sintering;

injection of material and polymerisation or sintering;

transfer of material and polymerisation or sintering.

The interconnection structure which can be placed on an electronic module according to the invention links conductive terminals for interconnection in the form of pellets of parametrable geometric forms, connected by tracks at the signal outlets of the substrate, in turn distributed on the surface or on the slice of the latter.

These geometric forms of the deposit conductive on the three-dimensional surface of the insulating coating can especially be done by:

etching of a initially uniform conductive deposit;

chemical attack of an initially uniform conductive deposit;

selective deposit by stencil of a conductive surface;

selective deposit of conductive material by chemical or electrochemical affinity with the insulating materials of the coating on which said deposit is carried out.

According to the invention, electrical functions of equivalent passive diagrams can be realised for example by associating the embodiments of conductive block plans and of conductive surfaces of geometrically parametrable forms such that these elements are separated by insulating materials, and that the choice of the:

electrical characteristics of the insulating and conductive materials;

thickness of the deposit of the insulating and conductive materials;

forms and sizes of the resulting conductive surfaces provide electrical functions such as capacitances, inductive resistances, resistors, and circuits equivalent to the association of these passive components.

As already pointed out, a module or a component according to the invention can make use of several iterations of depositing electrically conductive and insulating materials, so as to receive even more elements or functions. In addition, components mounted on the surface by brazing or by adhesion can be attached to conductive imprints made on the final surface of the module.

It is preferable that the insulating material for the coating supporting the conductive interconnection is chosen such that it exhibits a thermal expansion coefficient compatible with that of the material of the printed circuit to which it will be attached.

Advantageously, it can also be provided that a film, for example made of an organic photosensitive material, is attached to the surface above the coating and the metallic deposit, so as to ensure surface protection and economising on the zones defined for assembling the components.

To allow interconnection in the volume of the coating, between several successive conductive layers separated by insulating layers, one or more holes, for example cylindrical or conical, are made advantageously in the insulating layers, and which will be filled with conductive materials.

These interconnections in the volume of the coating are for example obtained by:

mechanical or laser boring;

chemical attack or any process for removing material;

mechanical moulding on the coating, or any process economising on the arrival of material on the coating in a predefined volume.

The deposit of conductive material in these holes can be carried out in particular by:

serigraphy or filling under pressure;

chemical and/or electrolytic baths; followed by the removal of excess conductive material.

Thermal drains, for evacuating the heat produced by certain coated components, or mounted on the surface of the module, can also be produced. These electrically conductive elements help dissipate the heat to the exterior of the module.

The interconnections in the volume can be utilised to connect the components of sources of heat to block plans, the latter then being connected to the printed circuit.

The electrically insulating elements can also be selected to be thermally conductive, especially when they coat components of heat sources, so as to dissipate this heat to the exterior, and for example towards radiators.

1. A production process for a component or a module combining in a housing to be mounted on a printed circuit a component assembly mounted on a substrate, wherein the process comprises at least a coating stage by means of an insulating material of at least a part of said module and at least a production stage, on a part of said insulating material, of at least one conductive zone, so as to define zones forming and/or capable of receiving at least a part of a component and/or at least an interconnection element.

2. The process as claimed in claim 1, wherein at least one of said conductive zones defines an interconnection structure, allowing said module to be attached to the printed circuit.

3. The process as claimed in claim 2, wherein said interconnection structure has at least one connection point, and at least one corresponding link, extending on at least ae a lateral edge of said housing as far as said substrate.

4. The process as claimed in claim 2, wherein said interconnection structure allows an assembly on the printed circuit by brazing.

5. The process as claimed in claim 4, wherein said interconnection structure allows an assembly on the printed circuit according to a CMS technique.

6. The process as claimed in claim 1, wherein at least one of said conductive zones defines a passive component.

7. The process as claimed in claim 6, wherein the or said passive components belong to the group comprising capacitors, inductive resistors and resistors, and their combinations.

8. The process as claimed in claim 1, wherein at least one of said conductive zones is an electrode of a capacitor whereof the dielectric is formed by said insulating material.

9. The process as claimed in claim 1, wherein said module comprises at least two conductive zones designed to receive at least one component.

10. The process as claimed in claim 9, wherein the or said components are mounted by brazing or by adhesion.

11. The process as claimed in claim 9, wherein the process comprises a prior coating stage of at least part of said components, and a metallization stage of the coated part, to ensure electro-magnetic shielding, then a final coating stage.

12. The process as claimed in claim 11, wherein said final coating stage is done by duplicate moulding.

13. The process as claimed in claim 11, wherein independent shielding is performed of at least two sub-assemblies of components.

14. The process as claimed in claim 13, claim 13, wherein at least one of said sub-assemblies is connected to an external radiator.

15. The process as claimed in claim 1, wherein said stages of coating and production of at least one conductive zone are reiterated at least once.

16. The process as claimed in claim 1, wherein the process comprises depositing a metallization layer forming a block plan.

17. The process as claimed in claim 1, wherein at least one opening filled with a conductive material passing through at least one layer of coating is made.

18. The process as claimed in claim 17, wherein the or said openings are conical or tapered.

19. The process as claimed in claim 17, wherein the or said openings are made by mechanical, laser boring, chemical attack or moulding of the coating.

20. The process as claimed in claim 17, wherein the or said openings are filled with a conductive material by serigraphy or pressurised filling, chemical and/or electrochemical baths.

21. The process as claimed in claim 1, wherein said insulating material is a plastic material.

22. The process as claimed in claim 1, wherein said insulating material has a thermal expansion coefficient selected such that it is compatible with that of the printed circuit material on which said component or module will be attached.

23. The process as claimed in claim 1, wherein said coating stage is selective, so as to spare on at least a portion of the surface of said substrate, in order to exhibit electrical continuity between at least one of said conductive zones and at least one of said surface portions.

24. The process as claimed in claim 1, wherein said coating stage is carried out by casting material, injecting material or transfer of material, then polymerisation or sintering.

25. The process as claimed in claim 1, wherein said production stage of at least one conductive zone comprises a metallization stage of the surface of said insulating material and a production stage of geometric forms eliminating a part of said metallization.

26. The process as claimed in claim 25, wherein said metallization stage comprises surface treatment by at least a chemical and/or electrochemical bath, conductive painting, pulverisation of conductive elements and/or vaporisation under vacuum.

27. The process as claimed in claim 25, wherein said production stage of geometric forms comprises three-dimensional etching by laser or by selective revelation (MID: Molded Interconnection Device) or chemical attack.

28. The process as claimed in claim 1, wherein the process comprises a stage for depositing a film made of an organic photosensitive material on said coating and the or said conductive zones.

29. The process as claimed in claim 1, wherein the process comprises a production stage of at least a thermal drain for aiding evacuation of the heat produced by at least one of said components.

30. A component or module combining in a housing to be mounted on a printed circuit a component assembly mounted on a substrate, wherein the component or module comprises an insulating material coating on at least part of said component or module and at least one conductive zone on part of said insulating material, so as to define zones forming and/or capable of receiving at least part of a component and/or at least an interconnection element.

31. The component or module as claimed in claim 30, wherein at least one of said conductive zones defines an interconnection structure allowing said component or module to be attached to a printed circuit.

32. The component or module as claimed in claim 30, wherein said component or module comprises at least a passive component defined by at least one of said conductive zones.

33. The component or module as claimed in claim 30, wherein said component or module comprises at least one capacitor whereof the dielectric of said capacitor is formed by said insulating material, and at least one electrode of said capacitor is formed by one of said conductive zones.

34. The component or module as claimed in claim 30, wherein said component or module carries at least one component connected to at least two of said conductive zones.
